(19) United States
(12) Patent Application Publication
(10) Pub. No.: US 2025/0055141 A1
(43) Pub. Date: Feb. 13, 2025

(54) POWER STORAGE CELL

(71) Applicant: TOYOTA JIDOSHA KABUSHIKI KAISHA, Toyota-shi (JP)

(72) Inventors: Takeru HARA, Toyota-shi (JP); Masato ONO, Nagoya-shi (JP); Satoshi MORIYAMA, Nagoya-shi (JP); Hiroki AWANO, Susono-shi (JP); Kazuya KUMAZAWA, Nagoya-shi (JP); Seigo FUJISHIMA, Miyoshi-shi (JP); Tomohiro INAGAKI, Okazaki-shi (JP)

(73) Assignee: TOYOTA JIDOSHA KABUSHIKI KAISHA, Toyota-shi (JP)

(21) Appl. No.: 18/776,695

(22) Filed: Jul. 18, 2024

(30) Foreign Application Priority Data
Aug. 10, 2023 (JP) 2023-131201

(51) Int. Cl. H01M 50/489; H01M 50/103; H01M 50/595; H01M 50/627

(52) U.S. Cl. CPC H01M 50/489; H01M 50/103; H01M 50/595; H01M 50/627

(57) ABSTRACT

A power storage cell comprises a case, an electrode assembly, an insulating film, and an electrolyte solution. The case accommodates the electrode assembly, the insulating film, and the electrolyte solution. The electrode assembly has an upper surface, a lower surface, and a peripheral surface. A liquid inlet hole is provided on a side of the case facing the upper surface. The peripheral surface connects the upper surface with the lower surface. The peripheral surface includes a first region and a second region. The first region is covered with the insulating film. The second region is not covered with the insulating film. The second region extends from the upper surface to reach the lower surface. The second region is smaller in area than the first region.

### CROSS REFERENCE TO RELATED APPLICATIONS

This nonprovisional application is based on Japanese Patent Application No. 2023-131201 filed on Aug. 10, 2023, with the Japan Patent Office, the entire contents of which are hereby incorporated by reference.

### BACKGROUND OF THE DISCLOSURE

### Field of the Disclosure

The present disclosure relates to a power storage cell.

### Description of the Background Art

Japanese Patent Laying-Open No. 2016-100270 discloses an insulating tape bonded to the outermost circumference of an electrode assembly.

### SUMMARY OF THE DISCLOSURE

A power storage cell comprises a case and an electrode assembly. The electrode assembly is placed inside the case. After the electrode assembly is placed inside, an electrolyte solution is injected into the case. From the viewpoint of energy density of the power storage cell, clearance between the case and the electrode assembly should be small. As the clearance becomes smaller, space around the electrode assembly available for distribution of the electrolyte solution may become smaller as well. When this happens, distribution of the electrolyte solution throughout the entire electrode assembly tends to take longer. Hence, there is room for improvement in the rate of impregnation of the electrolyte solution.

An object of the present disclosure is to enhance the rate of impregnation of electrolyte solution.

Hereinafter, the technical configuration and effects of the present disclosure will be described. It should be noted that the action mechanism includes presumption. The action mechanism does not limit the technical scope of the present disclosure.

1. A power storage cell comprises a case, an electrode assembly, an insulating film, and an electrolyte solution. The case accommodates the electrode assembly, the insulating film, and the electrolyte solution. The electrode assembly has an upper surface, a lower surface, and a peripheral surface. A liquid inlet hole is provided on a side of the case facing the upper surface. The peripheral surface connects the upper surface with the lower surface. The peripheral surface includes a first region and a second region. The first region is covered with the insulating film. The second region is not covered with the insulating film. The second region extends from the upper surface to reach the lower surface. The second region is smaller in area than the first region.

The electrolyte solution injected through the liquid inlet hole is supplied onto the upper surface of the electrode assembly. Due to the thickness of the insulating film, a gap may be formed between the second region and the case. This gap may serve as space for distribution of the electrolyte solution, allowing speedy supply of the electrolyte solution from the upper surface to the lower surface. As a result, the rate of impregnation is expected to be enhanced.

2. The power storage cell according to “1” above may include the following configuration, for example.

The power storage cell further includes an insulating member. The insulating member is placed on the case at a position facing the second region.

The insulating member is capable of electrically insulating the second region from the case.

3. The power storage cell according to “1” or “2” above may include the following configuration, for example.

The second region is placed below the liquid inlet hole.

When the second region is placed below the liquid inlet hole, the rate of impregnation is expected to be enhanced.

4. The power storage cell according to any one of “1” to “3” above may include the following configuration, for example.

The power storage cell further includes an insulating tape. The second region is bounded on both sides in a circumferential direction of the peripheral surface, by the first region. The insulating tape extends to link one side of the first region to the other side, straddling the second region.

The insulating tape is capable of electrically insulating the second region from the case.

5. The power storage cell according to any one of “1” to “4” above may include the following configuration, for example.

The insulating film has a belt-like shape.

The insulating film having a belt-like shape is suitable for affixing to the peripheral surface. When the insulating film has a belt-like shape, productivity is expected to be enhanced, for example.

6. The power storage cell according to any one of “1” to “5” above may include the following configuration, for example.

The insulating film is wrapped on the peripheral surface.

7. The power storage cell according to any one of “1” to “6” above may include the following configuration, for example.

The insulating film has a length direction and a width direction. The width direction is orthogonal to the length direction. A size of the insulating film in the length direction is smaller than a circumferential size of the peripheral surface.

With the length of the insulating film being shorter than the circumferential size of the peripheral surface, when the insulating film is wrapped on the peripheral surface, a gap may be formed between the starting edge of the insulating film and the ending edge thereof. In other words, the second region may be formed.

8. The power storage cell according to any one of “1” to “7” above may include the following configuration, for example.

The electrode assembly has a cubic outer shape. The electrode assembly is of stack type.

9. The power storage cell according to any one of “1” to “8” above may include the following configuration, for example.

The peripheral surface consists of the first region and the second region.

In the following, an embodiment of the present disclosure (which may also be simply called “the present embodiment” hereinafter) will be described. It should be noted that the present embodiment does not limit the technical scope of the present disclosure. The present embodiment is illustrative in any respect. The present embodiment is non-restrictive. The technical scope of the present disclosure encompasses any modifications within the meaning and the scope equivalent to the terms of the claims. For example, it is originally planned that any configurations of the present embodiment may be optionally combined.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic perspective view illustrating an example of a power storage cell according to the present embodiment.

FIG. 2 is a first schematic cross-sectional view illustrating an example of a power storage cell according to the present embodiment.

FIG. 3 is a schematic view illustrating an example of an electrode assembly according to the present embodiment.

FIG. 4 is a second schematic cross-sectional view illustrating an example of a power storage cell according to the present embodiment.

FIG. 5 is a schematic cross-sectional view illustrating an example of an electrode assembly according to the present embodiment.

### DESCRIPTION OF THE PREFERRED EMBODIMENTS

### 1. Terms

Terms such as “comprise”, “include”, and “have”, and other similar terms are open-ended terms. In an open-ended term, in addition to an essential component, an additional component may or may not be further included. The term “consist of” is a closed-end term. However, even in a configuration that is expressed by a closed-end term, impurities present under ordinary circumstances as well as an additional element irrelevant to the technique according to the present disclosure may be included. The term “consist essentially of” is a semiclosed-end term. A semiclosed-end term tolerates addition of an element that does not substantially affect the fundamental, novel features of the technique according to the present disclosure.

Any geometric term should not be interpreted solely in its exact meaning. Examples of geometric terms include “parallel”, “vertical”, “orthogonal”, and the like. For example, “parallel” may mean a geometric state that is deviated, to some extent, from exact “parallel”. Any geometric term herein may include tolerances and/or errors in terms of design, operation, production, and/or the like. The dimensional relationship in each figure may not necessarily coincide with the actual dimensional relationship. For the purpose of assisting understanding for the readers, the dimensional relationship in each figure may have been changed. For example, length, width, thickness, and the like may have been changed. Further, a part of a given configuration may have been omitted.

A numerical range such as “from m to n %” includes both the upper limit and the lower limit, unless otherwise specified. That is, “from m to n %” means a numerical range of “not less than m % and not more than n %”. Moreover, “not less than m % and not more than n %” includes “more than m % and less than n %”. Each of “not less than” and “not more than” is represented by an inequality symbol with an equality symbol, e.g., “≤”. Each of “more than” and “less than” is represented by an inequality symbol without an equality symbol, e.g., “<”. Any numerical value selected from a certain numerical range may be used as a new upper limit or a new lower limit. For example, any numerical value from a certain numerical range may be combined with any numerical value described in another location of the present specification or in a table or a drawing to set a new numerical range.

All the numerical values are regarded as being modified by the term “about”. The term “about” may mean ±5%, ±3%, ±1%, and/or the like, for example. Each numerical value may be an approximate value that can vary depending on the implementation configuration of the technique according to the present disclosure. Each numerical value may be expressed in significant figures. Unless otherwise specified, each measured value may be the average value obtained from multiple measurements performed. The number of measurements may be 3 or more, or may be 5 or more, or may be 10 or more. Generally, the greater the number of measurements is, the more reliable the average value is expected to be. Each measured value may be rounded off based on the number of the significant figures. Each measured value may include an error occurring due to an identification limit of the measurement apparatus, for example.

### 2. Power Storage Cell

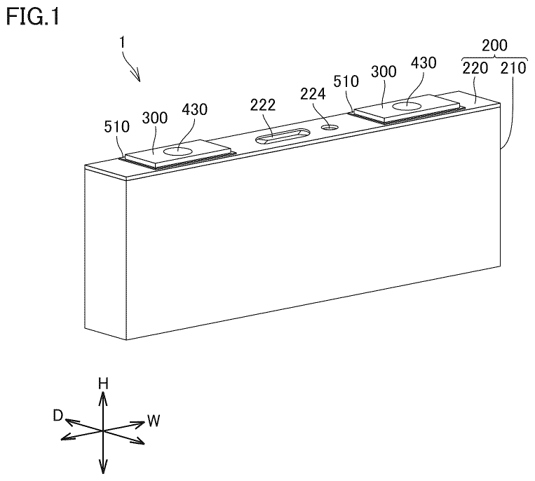

FIG. 1 is a schematic perspective view illustrating an example of a power storage cell according to the present embodiment. A power storage cell 1 may have a height direction, a width direction, and a thickness direction, for example. The height direction, the width direction, and the thickness direction are orthogonal to each other. The “height direction” is the direction H in FIG. 1 and the like. The “width direction” is the direction W in FIG. 1 and the like. The “thickness direction” is the direction D in FIG. 1 and the like. The height direction may be parallel to the vertical direction, for example. The width direction and the thickness direction may be parallel to the horizontal direction, for example. “Height” refers to the dimension in the height direction. “Width” refers to the dimension in the width direction. “Thickness” refers to the dimension in the thickness direction, or the thickness of a target.

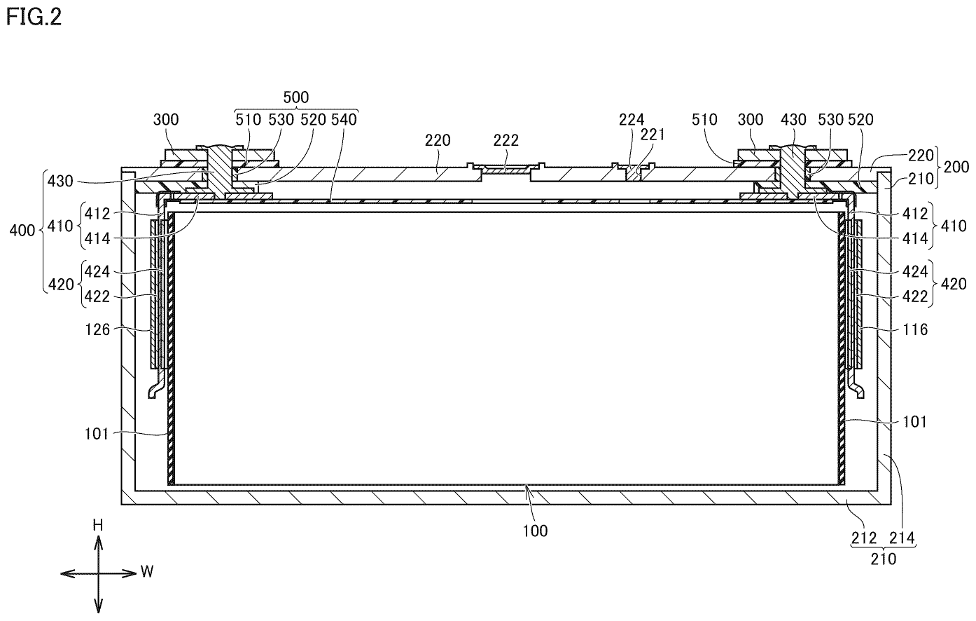

FIG. 2 is a first schematic cross-sectional view illustrating an example of a power storage cell according to the present embodiment. In FIG. 2, a cross section vertical to the thickness direction is shown. Power storage cell 1 includes a case 200, an electrode assembly 100, an insulating film 101, and an electrolyte solution (not illustrated). The electrolyte solution is a liquid electrolyte. The electrolyte solution may include an organic solvent, a lithium salt, and the like, for example.

### 3. Electrode Assembly, Insulating Film

Electrode assembly 100 may have a cubic outer shape, for example. Electrode assembly 100 may have a rectangular parallelepiped-like outer shape, for example. Electrode assembly 100 may be a flat, rectangular parallelepiped, for example.

A “first aspect ratio” refers to the ratio of the width of electrode assembly 100 to the height. The first aspect ratio may be 1 or more, or 1.5 or more, or 2 or more, or 2.5 or more, or 3 or more, or 5 or more, or 10 or more, for example. The first aspect ratio may be 10 or less, or 5 or less, or 3 or less, or 2.5 or less, or 2 or less, or 1.5 or less, for example. A “second aspect ratio” refers to the ratio of the thickness of electrode assembly 100 to the height. The second aspect ratio may be 0.1 or more, or 0.2 or more, or 0.3 or more, or 0.5 or more, or 1 or more, for example. The second aspect ratio may be 1 or less, or 0.5 or less, or 0.3 or less, or 0.2 or less, for example.

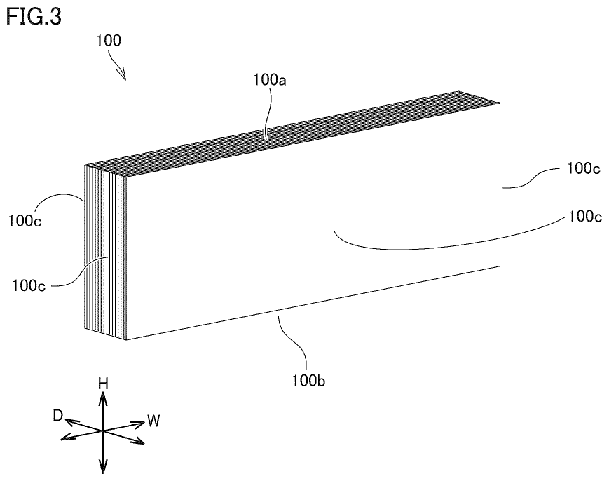

FIG. 3 is a schematic view illustrating an example of an electrode assembly according to the present embodiment. Electrode assembly 100 has an upper surface 100a, a lower surface 100b, and a peripheral surface 100c. Each of upper surface 100a, lower surface 100b, and peripheral surface 100c may be a flat surface, or may be an irregular surface. Upper surface 100a may be parallel to lower surface 100b. Peripheral surface 100c connects upper surface 100a to lower surface 100b. Peripheral surface 100c may include four flat planes. Each of the flat planes may be rectangular.

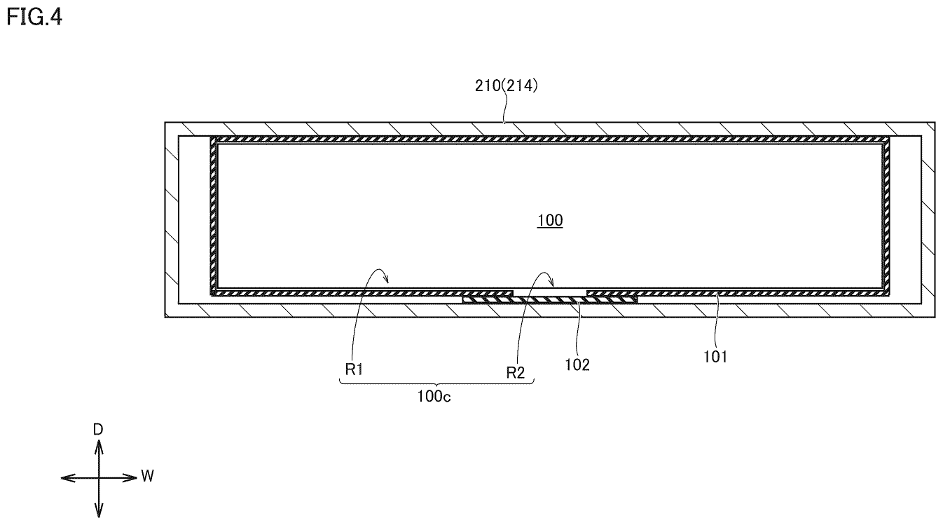

FIG. 4 is a second schematic cross-sectional view illustrating an example of a power storage cell according to the present embodiment. In FIG. 4, a cross section vertical to the height direction is shown. Peripheral surface 100c includes a first region R1 and a second region R2. Peripheral surface 100c may consist of first region R1 and second region R2.

First region R1 is covered with insulating film 101. Insulating film 101 may be affixed to first region R1. Insulating film 101 may be adhered to first region R1. For example, insulating film 101 may be adhered to first region R1 with adhesive material. First region R1 may be a continuous region. First region R1 may be divided in a plurality of parts.

Second region R2 is not covered with insulating film 101. Second region R2 may be a continuous region. Second region R2 may be divided in a plurality of parts. Second region R2 is bounded on both sides by first region R1. In the circumferential direction of peripheral surface 100c, second region R2 may be bounded by the starting edge of first region R1 and the ending edge of first region R1, for example. Second region R2 extends in the height direction. Second region R2 extends from upper surface 100a to reach lower surface 100b.

The area of second region R2 is smaller than the area of first region R1. The ratio of the area of second region R2 to the area of first region R1 may be 0.5 or less, or 0.4 or less, or 0.3 or less, or 0.2 or less, or 0.1 or less, or 0.05 or less, or 0.03 or less, or 0.01 or less, for example. The ratio of the area of second region R2 to the area of first region R1 may be 0.001 or more, or 0.005 or more, or 0.01 or more, or 0.05 or more, or 0.1 or more, for example.

When first region R1 is divided in a plurality of parts, the total area of all the parts is regarded as the area of first region R1. The same applies to second region R2.

Insulating film 101 has a length direction and a width direction. The width direction is orthogonal to the length direction. The width direction of insulating film 101 is parallel to the height direction. Insulating film 101 may have a belt-like shape, for example. The size of insulating film 101 in the length direction may be smaller than the circumferential size of peripheral surface 100c. With insulating film 101 shorter than the circumferential size wrapped on peripheral surface 100c, a continuous first region R1 may be formed.

The thickness of insulating film 101 may be 1 μm or more, or 5 μm or more, or 10 μm or more, or 50 μm or more, or 100 μm or more, or 500 μm or more, or 1 mm or more, for example. The thickness of insulating film 101 may be 2 mm or less, or 1 mm or less, or 500 μm or less, or 100 μm or less, or 50 μm or less, or 10 μm or less, or 5 μm or less, for example. The thickness of insulating film 101 may be uniform, or may vary depending on the position. A single insulating film 101 may be used alone. A plurality of insulating films 101 may be used. For example, a plurality of insulating films 101 may be stacked on top of one another. For example, a plurality of insulating films 101 may be connected to one another.

Insulating film 101 is electrically insulating. As long as it is electrically insulating, insulating film 101 may include any material. For example, insulating film 101 may be made of resin. For example, insulating film 101 may include at least one selected from the group consisting of polypropylene (PP), polyimide (PI), polyethylene (PE), polyethylene terephthalate (PET), and polyphenylene sulfide (PPS).

Power storage cell 1 may further include a first insulating member 102. The area of first insulating member 102 may be larger than the area of second region R2. The ratio of the area of first insulating member 102 to the area of second region R2 may be 1.01 or more, or 1.1 or more, or 1.2 or more, or 1.5 or more, or 2 or more, for example. The ratio of the area of first insulating member 102 to the area of second region R2 may be 2.5 or less, or 2.0 or less, or 1.5 or less, for example.

For example, first insulating member 102 may be placed on the surface of case 200. For example, first insulating member 102 may be placed on case 200 at a position facing second region R2. For example, first insulating member 102 may include an insulating coating material and/or the like. For example, a position of case 200 facing second region R2 may be coated with the insulating coating material. For example, the insulating coating material may include ceramic powder, resin powder, resin film, and/or the like.

For example, first insulating member 102 may include an insulating tape and/or the like. For example, the insulating tape may extend to link one side of first region R1 to the other side, straddling second region R2. For example, the insulating tape may extend to connect the starting edge of first region R1 with the ending edge of first region R1. The insulating tape may be affixed to insulating film 101, or may be affixed to case 200. The insulating tape may be thinner than insulating film 101, for example. The ratio of the thickness of the insulating tape to the thickness of insulating film 101 may be 1 or less, or 0.9 or less, or 0.8 or less, or 0.7 or less, or 0.6 or less, or 0.5 or less, for example. The ratio of the thickness of the insulating tape to the thickness of insulating film 101 may be 0.1 or more, or 0.2 or more, or 0.3 or more, or 0.4 or more, or 0.5 or more, for example.

The insulating tape may include a base material layer and an adhesive layer, for example. The adhesive layer is stacked on the base material layer. The base material layer may include the same material as that of insulating film 101, for example. The base material layer may have a thickness from 1 to 100 μm, for example. The adhesive layer may include at least one selected from the group consisting of acrylic-based adhesive material, silicone-based adhesive material, urethane-based adhesive material, and rubber-based adhesive material, for example.

### 4. Multilayer Structure

The electrode assembly may have any multilayer structure. For example, the electrode assembly may be a wound-type one. For example, the electrode assembly may be a stack-type one.

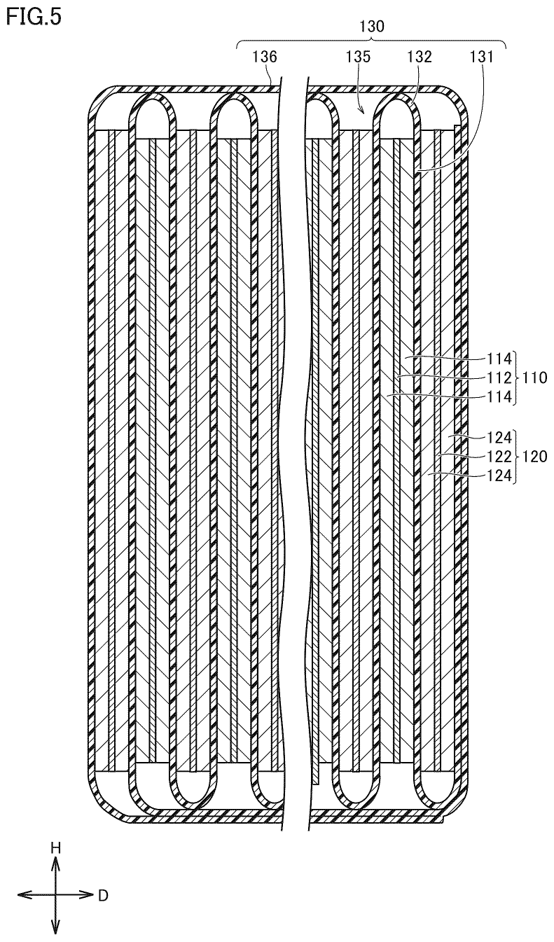

FIG. 5 is a schematic cross-sectional view illustrating an example of an electrode assembly according to the present embodiment. Electrode assembly 100 in FIG. 5 is a stack-type one. Electrode assembly 100 includes one or more first electrodes 110, one or more second electrodes 120, and one or more separators 130. In the thickness direction, first electrodes 110 and second electrodes 120 are alternately stacked. That is, the thickness direction of power storage cell 1 is parallel to the stacking direction of first electrodes 110 and second electrodes 120. The number of first electrodes 110 and the number of second electrodes 120 may be independently 2 or more, or 5 or more, or 10 or more, or 50 or more, or 100 or more. The number of first electrodes 110 and the number of second electrodes 120 may be independently 200 or less, or 100 or less, or 50 or less, or 10 or less, or 5 or less.

The polarity of second electrode 120 is different from the polarity of first electrode 110. For example, it is possible that first electrode 110 is a positive electrode and second electrode 120 is a negative electrode. For example, it is possible that first electrode 110 is a negative electrode and second electrode 120 is a positive electrode.

First electrode 110 may include a first current collector 112 and a first active material layer 114, for example. First current collector 112 may include a metal foil and/or the like, for example. The metal foil may include Al, Cu, Ni, Ti, Fe, and/or the like, for example. First active material layer 114 is placed on the surface of first current collector 112. First active material layer 114 may be placed on only one side of first current collector 112. First active material layer 114 may be placed on both sides of first current collector 112. First active material layer 114 includes a positive electrode active material or a negative electrode active material. The positive electrode active material may include lithium-nickel composite oxide and/or the like, for example. The negative electrode active material may include graphite, SiO, Si, and/or the like, for example.

Second electrode 120 may include a second current collector 122 and a second active material layer 124, for example. Second current collector 122 may include a metal foil and/or the like, for example. Second active material layer 124 is placed on the surface of second current collector 122. Second active material layer 124 may be placed on only one side of second current collector 122. Second active material layer 124 may be placed on both sides of second current collector 122. Second active material layer 124 includes a positive electrode active material or a negative electrode active material. The area of second active material layer 124 may be the same as, or may be different from, the area of first active material layer 114. For example, the area of second active material layer 124 may be greater than the area of first active material layer 114. The ratio of the area of second active material layer 124 to the area of first active material layer 114 may be 1.01 or more, or 1.05 or more, or 1.1 or more, for example. The ratio of the area of second active material layer 124 to the area of first active material layer 114 may be 1.1 or less, or 1.05 or less, or 1.01 or less, for example.

Separator 130 is electrically insulating. Separator 130 is porous. Separator 130 may include a polyolefin microporous film and/or the like, for example. The thickness of separator 130 may be from 5 to 50 μm, or may be from 5 to 30 μm, or may be from 5 to 15 μm, for example. Separator 130 separates first electrode 110 from second electrode 120. For example, two or more separators 130 may be used. For example, a single separator 130 may be inserted between each pair of first electrode 110 and second electrode 120.

For example, the number of separators 130 may be one. For example, separator 130 may include folded portions 135. With these folded portions 135, separator 130 is fanfolded. The “fanfolded” shape may also be expressed as “serpentine shape”, “accordion shape”, and the like, for example.

Folded portion 135 includes a planar portion 131 and a turn-back portion 132. At planar portion 131, separator 130 extends in a planar fashion. At turn-back portion 132, separator 130 is folded back. Turn-back portion 132 is provided at each end in the height direction. Separator 130 is folded back in such a manner that it holds first electrode 110 or second electrode 120, alternately, from both sides. First electrode 110 or second electrode 120 is held from both side by planar portion 131. Separator 130 may further include an outer peripheral portion 136, for example. Outer peripheral portion 136 may surround over folded portions 135. It should be noted that the folded portions may be formed by folding separator 130 every time it reaches a width-direction edge.

### 5. Case

Case 200 accommodates the electrolyte solution and electrode assembly 100. Case 200 may be hermetically enclosed. Case 200 may be hermetically sealed. Case 200 may include a can 210 and a lid 220, for example. Can 210 has an opening. The opening is open in the height direction. The opening may be open vertically upward, for example. Can 210 may be made of metal, for example. Can 210 may include Al and/or the like, for example. Can 210 may include a bottom wall 212 and a peripheral wall 214, for example. Bottom wall 212 may have a flat shape, for example. The planar shape of bottom wall 212 may be rectangular, for example. Peripheral wall 214 rises upward from bottom wall 212. Peripheral wall 214 may have a rectangular tubular shape, for example. The width of peripheral wall 214 may be greater than the thickness of peripheral wall 214. The height of peripheral wall 214 may be greater than the thickness of peripheral wall 214. Herein, “the thickness of peripheral wall 214” refers to the contour dimensions of case 200 in the thickness direction.

Lid 220 closes the opening of can 210. Lid 220 may be welded to peripheral wall 214. Lid 220 may have a flat shape, for example. Lid 220 may be made of metal, for example. Lid 220 may include Al and/or the like, for example. Lid 220 may include a pressure relief valve 222, a sealing member 224, and the like, for example.

Pressure relief valve 222 may be placed in lid 220 near the center thereof, for example. Pressure relief valve 222 releases the internal pressure of case 200. When the internal pressure reaches a certain value or above, pressure relief valve 222 may be opened. Sealing member 224 seals a liquid inlet hole 221. Through liquid inlet hole 221, the electrolyte solution may be injected.

The inner surface of lid 220 faces upper surface 100a of electrode assembly 100. In other words, liquid inlet hole 221 is provided on a side of case 200 facing upper surface 100a. Liquid inlet hole 221 may have a particular positional relationship with second region R2. Second region R2 may be placed below liquid inlet hole 221. For example, the angle formed by a straight line connecting second region R2 to liquid inlet hole 221 and the height direction may be 60° or less. This angle may be 45° or less, or 30° or less, or 15° or less, or 5° or less, or 3° or less, or 1° or less, for example. Second region R2 may be placed directly below liquid inlet hole 221, for example. In the width direction, the position of liquid inlet hole 221 may coincide with the position of second region R2, for example.

A pair of external terminals 300 are fixed to lid 220. External terminal 300 is connected to first electrode 110 or second electrode 120. External terminal 300 may be made of metal, for example. The external terminal may include Al, Cu, Ni, and/or the like. External terminal 300 may have a rectangular parallelepiped-like outer shape, for example. External terminal 300 may be connected to a bus bar (not illustrated).

A pair of connecting members 400 connect electrode tabs to external terminals 300. The electrode tab refers to a first electrode tab 116 or a second electrode tab 126. These two connecting members 400 may have substantially the same structure.

Connecting member 400 may include a current collector tab 410, a sub tab 420, and a connecting pin 430, for example. Current collector tab 410 includes a side portion 412 and an upper portion 414. Side portion 412 is located to a side of electrode assembly 100 in the width direction. Upper portion 414 is located above electrode assembly 100. Upper portion 414 extends inwardly in the width direction from the top of side portion 412.

Sub tab 420 connects a plurality of electrode tabs to current collector tab 410. Sub tab 420 may include a first edge 422 and a second edge 424. First edge 422 is connected to a plurality of electrode tabs. Second edge 424 is connected to side portion 412.

Connecting pin 430 connects current collector tab 410 to external terminal 300. Connecting pin 430 connects upper portion 414 with external terminal 300. For example, the lower end of connecting pin 430 may be inserted in a through hole that is provided in upper portion 414.

A second insulating member 500 electrically insulates case 200 from connecting member 400. Second insulating member 500 may include a first portion 510, a second portion 520, a third portion 530, and a fourth portion 540, for example.

First portion 510 is fixed to the upper surface of lid 220. First portion 510 is interposed between lid 220 and external terminal 300. Second portion 520 is fixed to the lower surface of lid 220. Second portion 520 is interposed between lid 220 and upper portion 414. Second portion 520 is interposed between lid 220 and the lower portion of connecting pin 430. Third portion 530 is interposed between connecting pin 430 and lid 220. Third portion 530 has a tubular shape. Third portion 530 surrounds connecting pin 430. In each of first portion 510, second portion 520, and third portion 530, a through hole is provided. In the through hole, connecting pin 430 is inserted.

Fourth portion 540 has a plate-like shape. It is fixed to the lower surface of upper portion 414. Fourth portion 540 is located above electrode assembly 100. A through hole is provided in fourth portion 540, at a position below pressure relief valve 222. Another through hole is provided in fourth portion 540, at a position below liquid inlet hole 221.

What is claimed is:

1. A power storage cell comprising:
a case;
an electrode assembly;
an insulating film; and
an electrolyte solution, wherein
the case accommodates the electrode assembly, the insulating film, and the electrolyte solution,
the electrode assembly has an upper surface, a lower surface, and a peripheral surface,
a liquid inlet hole is provided on a side of the case facing the upper surface,
the peripheral surface connects the upper surface with the lower surface,
the peripheral surface includes a first region and a second region,
the first region is covered with the insulating film,
the second region is not covered with the insulating film,
the second region extends from the upper surface to reach the lower surface, and
the second region is smaller in area than the first region.

2. The power storage cell according to claim 1, wherein
the power storage cell further includes an insulating member, and
the insulating member is placed on the case at a position facing the second region.

3. The power storage cell according to claim 1, wherein the second region is placed below the liquid inlet hole.

4. The power storage cell according to claim 1, wherein
the power storage cell further includes an insulating tape,
the second region is bounded on both sides in a circumferential direction of the peripheral surface, by the first region, and
the insulating tape extends to link one side of the first region to the other side, straddling the second region.

5. The power storage cell according to claim 1, wherein the insulating film has a belt-like shape.

6. The power storage cell according to claim 1, wherein the insulating film is wrapped on the peripheral surface.

7. The power storage cell according to claim 1, wherein
the insulating film has a length direction and a width direction,
the width direction is orthogonal to the length direction, and
a size of the insulating film in the length direction is smaller than a circumferential size of the peripheral surface.

8. The power storage cell according to claim 1, wherein
the electrode assembly has a cubic outer shape, and
the electrode assembly is of stack type.

9. The power storage cell according to claim 1, wherein the peripheral surface consists of the first region and the second region.
